(19) United States
(12) Patent Application Publication
(10) Pub. No.: US 2018/0017796 A1
(43) Pub. Date: Jan. 18, 2018

(54) VIRTUAL REALITY HAT APPARATUS

(71) Applicant: Nicolas A. Toso, Alexandria, VA (US)

(72) Inventor: Nicolas A. Toso, Alexandria, VA (US)

(21) Appl. No.: 15/650,182

(22) Filed: Jul. 14, 2017

Related U.S. Application Data
(60) Provisional application No. 62/362,345, filed on Jul. 14, 2016.

(51) Int. Cl. G02B 27/01; A42B 1/02; G02B 27/00; G09G 5/00

(52) U.S. Cl. CPC G02B 27/0172; A42B 1/02; G02B 27/00; G09G 5/00; G02B 2027/0174

(57) ABSTRACT

A virtual reality hat is a baseball style cap that functions as a virtual reality headset having a double brim that hinges at the attachment point of the crown and the bottom brim portion is able to hinge downward exposing a cell phone holder and a lens that function together to provide virtual reality to the wearer when desired. The brims collapse together in an instant to conceal the virtual reality headset.

### CROSS-REFERENCE TO RELATED APPLICATION

The present application is related to and claims priority from prior provisional application Ser. No. 62/362,345, filed Jul. 14, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of portable audio and video viewing devices and more specifically relates to a virtual reality hat apparatus.

### 2. Description of the Related Art

Currently, our technology for virtual reality devices (AR/VR/360 computer technology) is in a state of rapid development. Virtual reality is being used by the military extensively in training and in live operations. The consumer is also experiencing advancements in the technology as the uses for it expand into new areas besides computer generated gaming. As the future for virtual reality appears to increase in profitability and as the technology advances, more tech companies invest in research and development. Unfortunately, right now expensive headsets are out of the reach of the average consumer, and other cheaper headsets are not attractive or able to be used for anything other than in-home use. Less expensive headsets like the Google Cardboard viewer are easily ruined by water and are easily destroyed by small mishaps. The headsets currently on the market are bulky, and not practical to carry for spontaneous use. As AR/VR/360 becomes more commonly available, consumers will need a simple, convenient viewer that is easily and inconspicuously carried when not in use. An innovation that provides a solution to this problem is needed.

Various attempts have been made to solve the above-mentioned problems such as those found in U.S. Pub. No. 2012/0050144 to Clayton Richard Morlock; U.S. Pub. No. 2004/0180691 to Peter Cascone; U.S. Pub. No. 2004/0008157 to Curtis Brubaker; U.S. Pat. No. 9,101,174 to Michael Waters; and U.S. Pat. No. 9,332,797 to Daniel Jesse Abers. This prior art is representative of cap mounted video and audio display devices. None of the above inventions and patents, taken either singly or in combination, is seen to describe the invention as claimed.

Ideally, a portable audio and video viewing device should provide virtual reality viewing, carry convenience, and instant conceal ability, and yet, would operate reliably and be manufactured at a modest expense. Thus, a need exists for a reliable virtual reality hat apparatus to avoid the above-mentioned problems.

### BRIEF SUMMARY OF THE INVENTION

In view of the foregoing disadvantages inherent in the known portable audio and video viewing device art, the present invention provides a novel virtual reality hat. The general purpose of the present invention, which will be described subsequently in greater detail, is to provide virtual reality viewing, carry convenience, and instant conceal ability.

A virtual reality hat apparatus may comprise a crown portion that is adjustable and adapted to fit upon the heads of users having different head sizes, a first brim member attached to a front portion of the crown portion and extending outwardly therefrom over and above the wearer's eyes, and a second brim member attached to opposite side portions of the crown portion and extending outwardly therefrom and under a wearer's eyes.

The first and second brim members are adapted to hold an electronic device having an image screen therebetween at respective distal ends such that the image screen can be viewed by the wearer when the virtual reality hat is upon the wearer's head and the electronic device is placed therebetween. A pair of glasses that includes a frame member having two frame portions is adapted to respectively hold a lens member therein, and there is an adjustment member connected in between the two frame portions that is adapted to allow adjustment of the two frame portions with respect to one another and with respect to the first brim member. Two lens members are respectively held by the two frame portions and the pair of glasses is attached to the first brim member via the adjustment member extending downwardly therefrom and is adapted to be located in front of the wearer's eyes such that the wearer can view the image screen of the electronic device placed upon and between the respective distal ends of the first and second brim members through the pair of glasses.

When the electronic device emits a virtual reality image from the image screen, the wearer can view the virtual reality image through the pair of glasses. The adjustment member includes an elongated rectangular rack member having a plurality of spaced slots therein, and the frame member includes a cross-piece between the two frame portions adapted to releasably connect with a chosen one of the plurality of spaced slots of the rack member to thereby allow the wearer to choose a position of the pair of glasses with respect to the first brim member.

The crown portion includes an adjustable strap member on the rear portion that is adapted to allow a wearer to adjust the circumference to fit the wearer's head. The two lens members are formed as bi-convex lens members and are preferably formed from plastic.

A panel member is connected between the first and second brim members that is adapted to cover an area between the first and second brim members to block external light from reaching the wearer's eyes so the images being viewed are not reduced in clarity by reflected light. The panel member includes an aperture therethrough adapted to allow a camera member to be attached. The two lens members are formed having a 45 millimeter focal length and a 25 millimeter diameter but may be formed having a 45 millimeter focal length and a 37 millimeter diameter in alternate embodiments.

A virtual reality system may comprise a virtual reality electronic device including a main body, and an image screen on the main body adapted to project virtual reality images therefrom, and a virtual reality hat apparatus comprising a crown portion that is adjustable and adapted to fit upon heads of users of different sizes having a first brim member attached to a front portion of the crown portion extending outwardly therefrom that is adapted to extend outwardly over and above a wearer's eyes, and a second brim member attached to opposite side portions of the crown portion that extends outwardly therefrom that is adapted to extend outwardly under and below a wearer's eyes.

The first and second brim members are adapted to hold the electronic device therebetween at respective distal ends such that the image screen can be viewed by the wearer when the virtual reality hat is upon the wearer's head and the electronic device is placed therebetween. A pair of glasses including a frame member having two frame portions is adapted to respectively hold a lens member therein is included and has an adjustment member connected in between the two frame portions that are adapted to allow adjustment of the two frame portions with respect to one another and with respect to the first brim member. The two lens members are respectively held by the two frame portions, and the pair of glasses is attached to the first brim member via the adjustment member extending downwardly therefrom, and is adapted to be located in front of the wearer's eyes so that the wearer can view the image screen of the electronic device placed upon and between the respective distal ends of the first and second brim members through the pair of glasses. When the electronic device emits a virtual reality image from the image screen, the wearer can view the virtual reality image through the pair of glasses.

The adjustment member includes an elongated rectangular rack member having a plurality of spaced slots therein and the frame member includes a cross-piece between the two frame portions adapted to releasably connect with a chosen spaced slot of the rack member to thereby allow the wearer to choose a position of the pair of glasses with respect to the first brim member. The crown portion includes an adjustable strap member on the rear portion adapted to allow a wearer to adjust the circumference of the strap for various sizes of user's heads. The two lens members are formed as bi-convex lens members and are preferably formed from plastic.

A panel member connected between the first and second brim members is adapted to cover the area between the first and second brim members to block external light from reaching the wearer's eyes. The panel member includes an aperture therethrough adapted to allow a camera member to be attached therein. The two lens members are formed having a 45 millimeter focal length and a 25 millimeter diameter but may be formed having a 45 millimeter focal length and a 37 millimeter diameter in some embodiments. The camera member is connected within the aperture of the panel member and is adapted to be electronically connected to the virtual reality electronic device to send captured images to the virtual reality electronic device for emitting from the image screen.

At least one ear phone member is connected to the virtual reality hat and electronically connected to the virtual reality electronic device, to thereby play audio sent by the virtual reality electronic device therethrough for listening by the wearer.

The present invention holds significant improvements and serves as a virtual reality hat. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, virtual reality hat apparatus, constructed and operative according to the teachings of the present invention.

FIG. 1 shows a perspective view illustrating a virtual reality hat apparatus according to an embodiment of the present invention.

FIG. 2 is a perspective view illustrating a virtual reality hat apparatus according to an embodiment of the present invention of FIG. 1.

FIG. 3 is a perspective view illustrating virtual reality hat apparatus according to an embodiment of the present invention of FIG. 1.

FIG. 4 is a perspective view illustrating virtual reality hat apparatus according to an embodiment of the present invention of FIG. 1.

FIG. 5 is a perspective view illustrating virtual reality hat apparatus according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a portable audio and video viewing device and more particularly to a virtual reality hat as used to improve the virtual reality viewing, carry convenience, and instant conceal ability.

Generally speaking, a virtual reality hat apparatus is a baseball style cap that functions as a virtual reality headset having a double brim that hinges at the attachment point of the crown and the bottom brim portion is able to hinge downward exposing a cell phone holder and a lens that function together to provide virtual reality to the wearer when desired. The brims collapse together in an instant to conceal the virtual reality headset.

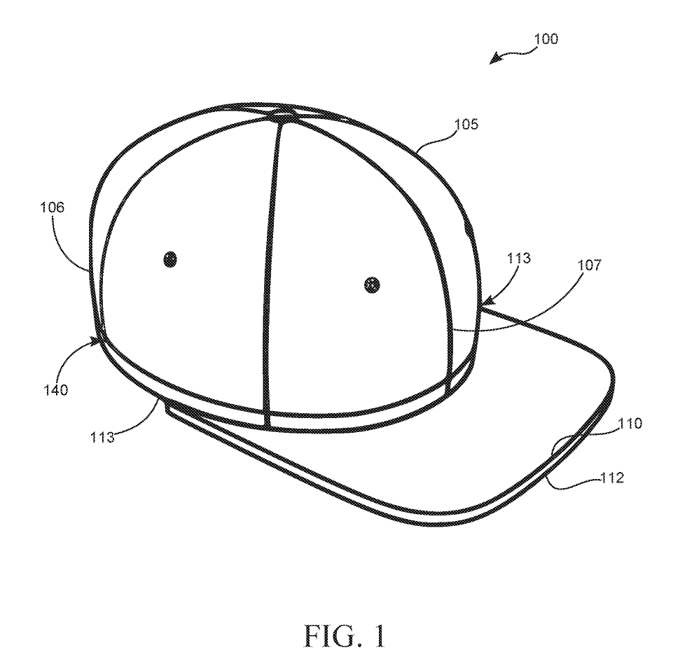

Referring to the drawings by numerals of reference there is shown in FIG. 1, a perspective view illustrating virtual reality hat apparatus 100 according to an embodiment of the present invention.

Virtual reality hat apparatus 100 is designed to look inconspicuously like a baseball cap when it is not in use but yet has the convenience of being instantly deployable and allows the user to become immersed in another environment when in use. For instance, the user can be seated in a stadium at the most distant point in the stadium from the action, and yet, have the visual experience of being as close as the network cameras are to the action that is being viewed in real time. The user may also alternate back and forth between the seated position and the network camera positions. The device may be used for entertainment, but also has educational or scientific values as well since the technology is not limited to a singular purpose. It should be noted that Virtual reality hat apparatus 100 is not limited to only Virtual reality technology and my also be used in conjunction with both “Augmented Reality” and “Mixed Reality.”

In greater detail, virtual reality hat apparatus 100 may comprise crown portion 105 that is adjustable and adapted to fit upon the heads of users having different head sizes, first brim member 110 attached to front portion 107 of crown portion 105 and extending outwardly therefrom over and above the wearer's eyes, and second brim member 112 attached to opposite side portions 113 of crown portion 105 and extending outwardly therefrom and under a wearer's eyes.

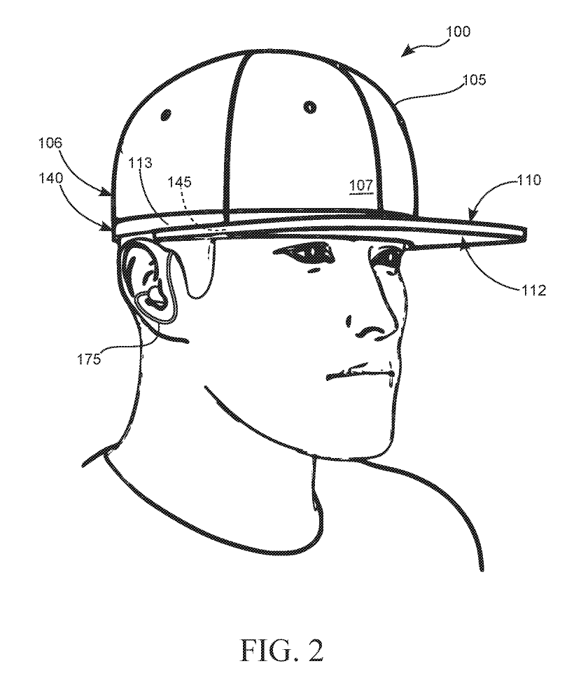

Referring now to FIG. 2, is a perspective view illustrating virtual reality hat apparatus 100 according to an embodiment of the present invention of FIG. 1.

First brim member 110 and second brim member 112 are adapted to hold electronic device 115 having image screen 116 therebetween at respective distal ends 117 such that image screen 116 can be viewed by the wearer when virtual reality hat apparatus 100 is upon the wearer's head and electronic device 115 is placed therebetween. Pair of glasses 120 that includes frame member 121 having two frame portions 122 is adapted to respectively hold lens member 125 therein, and there is adjustment member 130 connected in between the two frame portions 122 that is adapted to allow adjustment of the two frame portions 122 with respect to one another and with respect to first brim member 110. Two lens members 125 are respectively held by the two frame portions 122 and pair of glasses 120 is attached to first brim member 110 via adjustment member 130 extending downwardly therefrom and is adapted to be located in front of the wearer's eyes such that the wearer can view image screen 116 of electronic device 115 placed upon and between the respective distal ends 117 of first brim member 110 and second brim member 112 through pair of glasses 120.

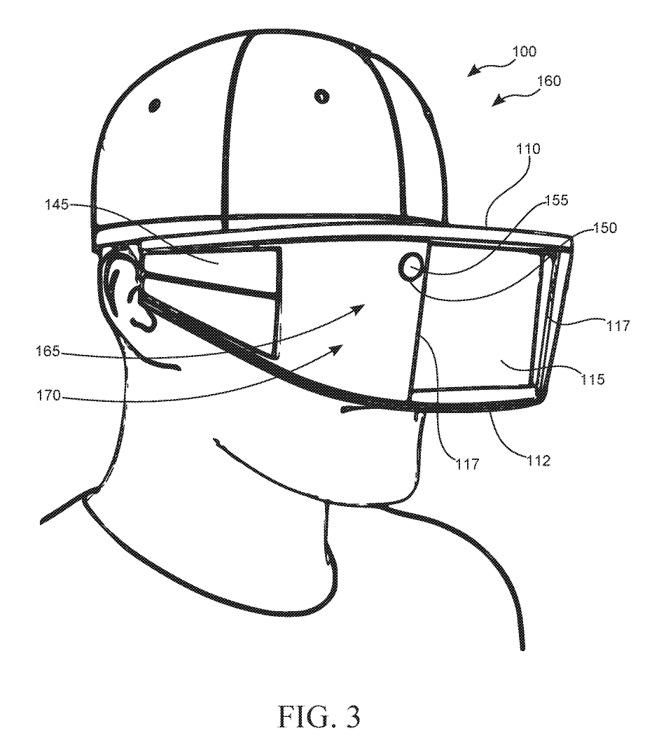

Referring now to FIG. 3, is a perspective view illustrating virtual reality hat apparatus 100 according to an embodiment of the present invention of FIG. 1.

When electronic device 115 emits a virtual reality image from image screen 116, the wearer can view the virtual reality image through pair of glasses 120. Adjustment member 130 includes an elongated rectangular rack member 135 having a plurality of spaced slots 136 therein, and frame member 121 includes cross-piece 137 between the two frame portions 122 adapted to releasably connect with a chosen one of the plurality of spaced slots 136 of rectangular rack member 135 to thereby allow the wearer to choose a position of pair of glasses 120 with respect to first brim member 110.

Crown portion 105 includes adjustable strap member 140 on rear portion 106 that is adapted to allow a wearer to adjust the circumference to fit the wearer's head. The two lens members 125 are formed as bi-convex lens members 126 and are preferably formed from plastic.

Panel member 145 connected between first brim members 110 and second brim member 112 is adapted to cover the area between first brim member 110 and second brim members 112 to block external light from reaching the wearer's eyes. Panel member 145 includes aperture 150 therethrough adapted to allow camera member 155 to be attached therein. The two lens members 125 are formed having a 45 millimeter focal length and a 25 millimeter diameter but may be formed having a 45 millimeter focal length and a 37 millimeter diameter in some embodiments. Camera member 155 is connected within aperture 150 of panel member 145 and is adapted to be electronically connected to virtual reality electronic device 165 to send captured images to virtual reality electronic device 165 for emitting from image screen 116.

At least one ear phone member 175 is connected to virtual reality hat apparatus 100 and electronically connected to virtual reality electronic device 165, to thereby play audio sent by virtual reality electronic device 165 therethrough for listening by the wearer.

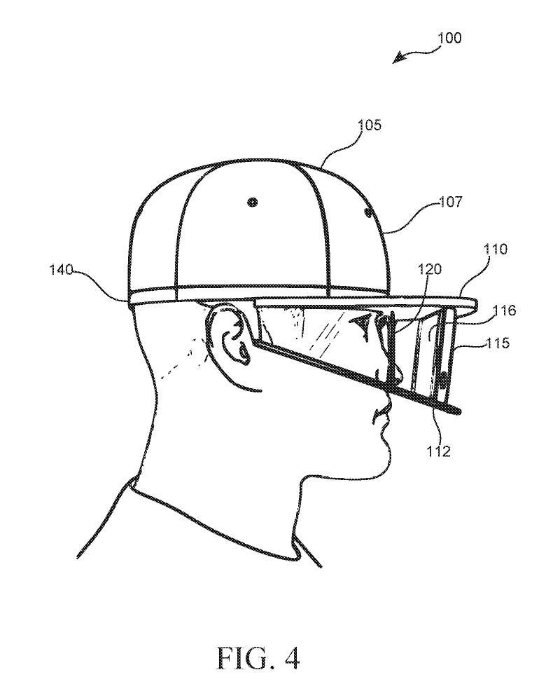

Referring now to FIG. 4, is a perspective view illustrating virtual reality hat apparatus 100 according to an embodiment of the present invention of FIG. 1.

Panel member 145 is connected between first brim member 110 and second brim member 112 that is adapted to cover an area between first brim member 110 and second brim member 112 to block external light from reaching the wearer's eyes so the images being viewed are not reduced in clarity by reflected light. Panel member 145 includes aperture 150 therethrough adapted to allow camera member 155 to be attached. The two lens members 125 are formed having a 45 millimeter focal length and a 25 millimeter diameter but may be formed having a 45 millimeter focal length and a 37 millimeter diameter in alternate embodiments.

Virtual reality system 160 may comprise virtual reality electronic device 165 including main body 170, and image screen 116 on main body 170 adapted to project virtual reality images therefrom, and virtual reality hat apparatus 100 comprising crown portion 105 that is adjustable and adapted to fit upon heads of users of different sizes having first brim member 110 attached to front portion 107 of crown portion 105 extending outwardly therefrom that is adapted to extend outwardly over and above a wearer's eyes, and second brim member 112 attached to opposite side portions 113 of crown portion 105 that extends outwardly therefrom that is adapted to extend outwardly under and below a wearer's eyes.

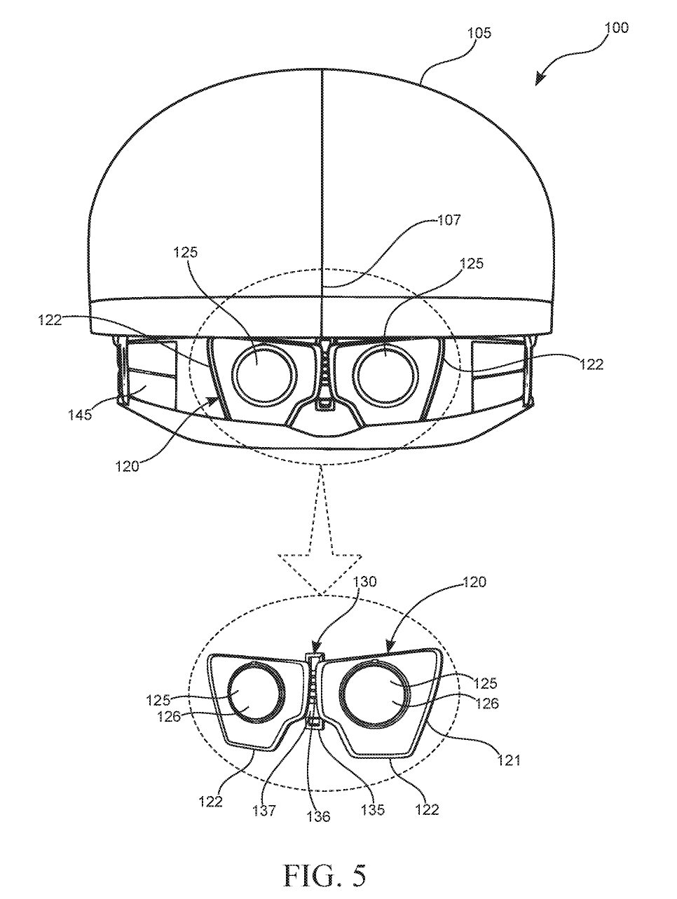

Referring now to FIG. 5, a perspective view illustrating virtual reality hat apparatus according to an embodiment of the present invention of FIG. 1.

First brim member 110 and second brim members 112 are adapted to hold electronic device 115 therebetween at respective distal ends 117 such that image screen 116 can be viewed by the wearer when virtual reality hat apparatus 100 is upon the wearer's head and electronic device 115 is placed therebetween. Pair of glasses 120 including frame member 121 having two frame portions 122 is adapted to respectively hold lens members 125 therein is included and has adjustment member 130 connected in between the two frame portions 122 that are adapted to allow adjustment of the two frame portions 122 with respect to one another and with respect to first brim member 110. The two lens members 125 are respectively held by the two frame portions 122, and pair of glasses 120 is attached to first brim member 110 via adjustment member 130 extending downwardly therefrom, and is adapted to be located in front of the wearer's eyes so that the wearer can view image screen 116 of electronic device 115 placed upon and between the respective distal ends 117 of the first 110 and second brim member 112 through pair of glasses 120. When electronic device 115 emits a virtual reality image from image screen 116, the wearer can view the virtual reality image through pair of glasses 120.

Adjustment member 130 includes an elongated rectangular rack member 135 having a plurality of spaced slots 136 therein and frame member 121 includes cross-piece 137 between the two frame portions 122 adapted to releasably connect with a chosen spaced slot of rectangular rack member 135 to thereby allow the wearer to choose a position of pair of glasses 120 with respect to first brim member 110. Crown portion 105 includes adjustable strap member 140 on rear portion 106 adapted to allow a wearer to adjust the circumference of adjustable strap member 140 for various sizes of user's heads. The two lens members 125 are formed as bi-convex lens members 125 and are preferably formed from plastic.

Virtual reality hat 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A virtual reality hat apparatus comprising:
a crown portion;
wherein said crown portion is adjustable and adapted to fit upon heads of different sizes; and
a first brim member;
wherein said first brim member is attached to a front portion of said crown portion and extends outwardly therefrom and is adapted to extend outwardly over and above a wearer's eyes;
a second brim member;
wherein said second brim member is attached to opposite side portions of said crown portion and extends outwardly therefrom and is adapted to extend outwardly under and below a wearer's eyes;
wherein said first and second brim members are adapted to hold an electronic device having an image screen therebetween at respective distal ends thereof, such that said image screen can be viewed by said wearer when said virtual reality hat is upon said wearer's head and said electronic device is placed therebetween; and
a pair of glasses including;
a frame member including;
two frame portions;
wherein said two frame portions are adapted to respectively hold a lens member therein;
and
an adjustment member;
wherein said adjustment member is connected in between said two frame portions and is adapted to allow adjustment of said two frame portions with respect to one another and with respect to said first brim member;
and
two lens members;
wherein said two lens members are respectively held by said two frame portions; and
wherein said pair of glasses are attached to said first brim member via said adjustment member, extend downwardly therefrom, and are adapted to be located in front of said wearer's eyes, such that said wearer can view said image screen of said electronic device placed upon and between said respective distal ends of said first and second brim members through said pair of glasses; and
wherein when said electronic device emits a virtual reality image from said image screen, said wearer can view said virtual reality image through said pair of glasses.

2. The virtual reality hat of claim 1, wherein said adjustment member includes an elongated rectangular rack member having a plurality of spaced slots therein; and wherein said frame member includes a cross-piece between said two frame portions adapted to releasably connect with a chosen one of said plurality of spaced slots of said rack member, to thereby allow said wearer to choose a position of said pair of glasses with respect to said first brim member.

3. The virtual reality hat of claim 1, wherein said crown portion includes and adjustable strap member on a rear portion thereof adapted to allow a wearer to adjust the circumference thereof.

4. The virtual reality hat of claim 1, wherein said two lens members are formed as bi-convex lens members.

5. The virtual reality hat of claim 1, wherein said two lens members are formed from plastic.

6. The virtual reality hat of claim 1, further comprising a panel member connected between said first and second brim members and adapted to cover an area between said first and second brim members, to thereby be adapted to block external light from reaching said wearer's eyes.

7. The virtual reality hat of claim 1, wherein said panel member includes an aperture therethrough adapted to allow a camera member to be attached therein.

8. The virtual reality hat of claim 1, wherein said two lens members are formed having a 45 millimeter focal length and a 25 millimeter diameter.

9. The virtual reality hat of claim 1, wherein said two lens members are formed having a 45 millimeter focal length and a 37 millimeter diameter.

10. A virtual reality system comprising:
a virtual reality electronic device including:
a main body; and
an image screen on said main body adapted to project virtual reality images therefrom; and
a virtual reality hat apparatus comprising:
a crown portion;
wherein said crown portion is adjustable and adapted to fit upon heads of different sizes; and
a first brim member;
wherein said first brim member is attached to a front portion of said crown portion and extends outwardly therefrom and is adapted to extend outwardly over and above a wearer's eyes;
a second brim member;
wherein said second brim member is attached to opposite side portions of said crown portion and extends outwardly therefrom and is adapted to extend outwardly under and below a wearer's eyes;
wherein said first and second brim members are adapted to hold said electronic device therebetween at respective distal ends thereof, such that said image screen can be viewed by said wearer when said virtual reality hat is upon said wearer's head and said electronic device is placed therebetween; and
a pair of glasses including;
a frame member including;
two frame portions;
wherein said two frame portions are adapted to respectively hold a lens member therein;
and
an adjustment member;
wherein said adjustment member is connected in between said two frame portions and is adapted to allow adjustment of said two frame portions with respect to one another and with respect to said first brim member;
and
two lens members;
wherein said two lens members are respectively held by said two frame portions; and
wherein said pair of glasses are attached to said first brim member via said adjustment member, extend downwardly therefrom, and are adapted to be located in front of said wearer's eyes, such that said wearer can view said image screen of said electronic device placed upon and between said respective distal ends of said first and second brim members through said pair of glasses; and
wherein when said electronic device emits a virtual reality image from said image screen, said wearer can view said virtual reality image through said pair of glasses.

11. The virtual reality system of claim 10, wherein said adjustment member includes an elongated rectangular rack member having a plurality of spaced slots therein; and wherein said frame member includes a cross-piece between said two frame portions adapted to releasably connect with a chosen one of said plurality of spaced slots of said rack member, to thereby allow said wearer to choose a position of said pair of glasses with respect to said first brim member.

12. The virtual reality system of claim 10, wherein said crown portion includes and adjustable strap member on a rear portion thereof adapted to allow a wearer to adjust the circumference thereof.

13. The virtual reality system of claim 10, wherein said two lens members are formed as bi-convex lens members.

14. The virtual reality system of claim 10, wherein said two lens members are formed from plastic.

15. The virtual reality system of claim 10, further comprising a panel member connected between said first and second brim members and adapted to cover an area between said first and second brim members, to thereby be adapted to block external light from reaching said wearer's eyes.

16. The virtual reality system of claim 10, wherein said panel member includes an aperture therethrough adapted to allow a camera member to be attached therein.

17. The virtual reality hat of claim 10, wherein said two lens members are formed having a 45 millimeter focal length and a 25 millimeter diameter.

18. The virtual reality hat of claim 10, wherein said two lens members are formed having a 45 millimeter focal length and a 37 millimeter diameter.

19. The virtual reality system of claim 16, further comprising a camera member connected within said aperture of said panel member, and adapted to be electronically connected to said virtual reality electronic device to thereby send images captured therewith and send to said virtual reality electronic device for emitting from said image screen.

20. The virtual reality system of claim 10, further comprising at least one ear phone member connected to said virtual reality hat and electronically connected to said virtual reality electronic device, to thereby play audio sent by said virtual reality electronic device therethrough for listening by said wearer.
